(19) United States
(12) Patent Application Publication
(10) Pub. No.: US 2023/0281023 A1
(43) Pub. Date: Sep. 7, 2023

(54) AUTOMATIC CREATION OF WORKFLOW AUTOMATION

(71) Applicant: SAP SE, Walldorf (DE)

(72) Inventors: Nathan BIENFAIT, Paris (FR); Andrew BROWN, Paris (FR); Louis RAKOTOARIVONY, Verrieres le Buisson (FR)

(21) Appl. No.: 17/688,200

(22) Filed: Mar. 7, 2022

(51) Int. Cl. G06F 9/451; G06F 8/65

(52) U.S. Cl. CPC G06F 9/451; G06F 8/65

(57) ABSTRACT

Systems and methods include determination of an executing application, detection of user interactions with one or more elements of a user interface of the application, storage of data representing the one or more elements of the user interface of the application and the detected user interactions, and generation, based on the stored data, of an automation executable to automatically execute the detected user interactions on the user interface of the application.

### BACKGROUND

Software applications, executed on-premise or in the cloud, have profoundly increased the efficiency with which many tasks can be performed. Software-based automation systems provide further benefits by allowing non-technical users to design software-driven workflows and execute the workflows on their local computing systems with little or no human intervention. The workflows may be used, for example, to perform automatic processing of incoming and/or stored data, in response to a trigger or according to a defined temporal schedule.

Conventional automation systems require a user to manually capture each application to be used in a workflow, the user interfaces of the applications, and the particular elements within the user interfaces with which a user may interact. Next, the user manually creates automations using tools provided by the automation system. Specifically, the user may define a sequence of activities to be executed with respect to various ones of the defined user interface elements.

These requirements are time-consuming and error-prone, particularly when applied to the non-technical user for whom such automated systems are intended. In one non-exhaustive example, the user is required to open a client-side application of the automation system on their local computing system, open all target applications, select each application from a presented list within the client-side application, operate various user interface elements to capture the applications, add additional user interfaces of the applications, define elements of each user interface as well as corresponding detection criteria, and perform testing to validate the definitions. Moreover, to create an automation based on the definitions, the user must operate the automation system to define a workflow of activities to manipulate the defined applications, user interfaces and elements. The thusly-created automation must then be tested and debugged accordingly.

Systems to generate automated workflows efficiently and with reduced development time and errors are desired.

### BRIEF DESCRIPTION OF THE DRAWINGS

FIG. 1 is a block diagram of an architecture to automatically generate automations based on user interactions with one or more applications according to some embodiments.

FIG. 2 comprises a flow diagram of a process to automatically generate automations based on user interactions with one or more applications according to some embodiments.

FIG. 3 is a view of a user interface of an application presented by a computing device according to some embodiments.

FIG. 4 is a view of a user interface of an application and a user interface of a recorder application presented by a computing device according to some embodiments.

FIG. 5 is a view of a user interface of an application and a user interface of a recorder application presented by a computing device according to some embodiments.

FIG. 6 is a view of a user interface of an application and a user interface of a recorder application presented by a computing device according to some embodiments.

FIG. 7 is a view of a user interface of an application and a user interface of a recorder application presented by a computing device according to some embodiments.

FIG. 8 is a view of a user interface of an application and a user interface of a recorder application presented by a computing device according to some embodiments.

FIG. 9 is a view of a user interface of an automation application according to some embodiments.

FIG. 10 is a view of a user interface of an automation application according to some embodiments.

FIG. 11 is a block diagram of an architecture to automatically generate automations based on user interactions with one or more applications according to some embodiments.

FIG. 12 is a block diagram of an architecture to automatically generate automations based on monitored user interactions with one or more applications according to some embodiments.

FIG. 13 comprises a flow diagram of a process to automatically generate automations based on monitored user interactions with one or more applications according to some embodiments.

FIG. 14 is a view of a user interface of an automation application according to some embodiments.

FIG. 15 is a view of a user interface of an automation application according to some embodiments.

FIG. 16 is a view of a user interface of an automation application according to some embodiments.

FIG. 17 is a view of a user interface of an automation application according to some embodiments.

FIG. 18 is a view of a user interface of an automation application according to some embodiments.

FIG. 19 is a block diagram of an architecture to automatically generate automations based on monitored user interactions with one or more applications according to some embodiments.

FIG. 20 is a block diagram of a cloud-based system according to some embodiments.

### DETAILED DESCRIPTION

The following description is provided to enable any person in the art to make and use the described embodiments. Various modifications, however, will be readily-apparent to those in the art.

Some embodiments provide efficient systems to automatically create workflow automations. For example, some embodiments operate to store data representing a user interface of an application executing on a local computing system, and to store data representing user interactions with the user interface. Based on the stored data, an automation system generates an automation to cause execution of the detected user interactions on the user interface of the locally-executed application. According to some embodiments, a user may operate the automation system to edit and/or otherwise modify the generated automation as desired.

Some embodiments operate to store data representing logical elements of a user interface of an application executing on a local computing system. Also stored are data representing user interactions with the user interface, which may comprise traces which associated user actions with logical elements of the user interface. In response to a command to generate an automation, the data are converted to formats associated with an automation system and the converted data are transmitted to the automation system. The automation system then generates an automation based on the converted data, where the automation is to cause execution of the detected user interactions on the user interface of the locally-executed application. The generated automation may be edited and/or otherwise modified as desired.

By virtue of some embodiments, automations which mimic actual interactions between a user and an application user interface may be generated automatically. Embodiments may therefore generate automations while avoiding manually defining user interfaces, user interface elements, and user interactions, which is both time-consuming and error-prone. Consequently, automations may be generated more quickly and more accurately than previously possible.

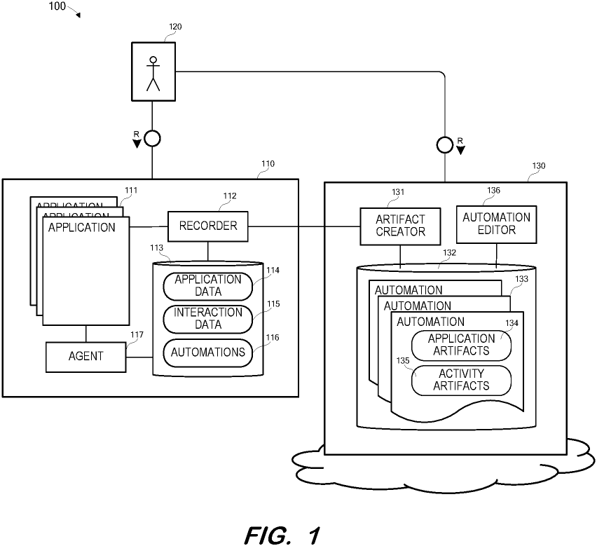

FIG. 1 is a block diagram of architecture 100 according to some embodiments. The illustrated elements of architecture 100 and of all other architectures depicted herein may be implemented using any suitable combination of computing hardware and/or software that is or becomes known. Such combinations may include one or more programmable processors (microprocessors, central processing units, microprocessor cores, execution threads), one or more non-transitory electronic storage media, and processor-executable program code. In some embodiments, two or more elements of architecture 100 are implemented by a single computing device, and/or two or more elements of architecture 100 are co-located. One or more elements of architecture 100 may be implemented using cloud-based resources, and/or other systems which apportion computing resources elastically according to demand, need, price, and/or any other metric.

Local computing system 110 may comprise a computing system operated by local user 120. Local computing system 110 may comprise a laptop computer, a desktop computer, or a tablet computer, but embodiments are not limited thereto. Local computing system 110 may consist of any combination of computing hardware and software suitable to allow system 110 to execute program code to cause computing device 110 to perform the functions described herein and to store such program code and associated data.

Generally, computing system 110 executes one or more of applications 111 to provide functionality to user 120. Applications 111 may comprise any software applications that are or become known, including but not limited to office productivity applications (e.g., document editing, spreadsheet, and calendaring applications) and data analytics applications. As will be described below, applications 111 may comprise standalone applications and/or web applications which execute within a web browser of system 110 and interact with corresponding remote cloud-based applications to provide desired functionality. User 120 may instruct system 110 as is known to execute one or more of applications 111 and may interact with resulting displayed user interfaces of the executing applications 111 to obtain the desired functionality therefrom.

Recorder 112 may comprise program code executable by system 110 to generate and store data representing user interactions with applications 111. Storage device 113 represents any suitable combination of volatile (e.g., Random Access Memory) and non-volatile (e.g., fixed disk) memory used by system 110 to store the data generated by recorder 112. For example, application data 114 may comprise images of application user interfaces, as well as data defining various elements of such user interfaces. As will be described below, an element may be defined by its location and dimensions within a user interface, its type (e.g., text box, drop-down menu, selectable toggle), and an identifier. Interaction data 115 may represent individual interactions (e.g., clicks, selections and text entries) of a user with elements of one or more user interfaces. For example, over a user-designated period of time, recorder 112 may generate and store interaction data 115 which indicates a sequence of user interactions performed on various elements of a user interface.

Recorder 112 may also export application data 114 and interaction data 115 to automation system 130. Automation system 130 may comprise an on-premise server, a cloud-deployed virtual machine, or any other suitable computing system to provide the functions described herein. Automation system 130 of FIG. 1 is depicted upon a cloud in order to represent an embodiment providing resource elasticity and communication via Web communication protocols, but embodiments are not limited thereto.

Automation system 130 includes program code executable to provide artifact creator 131. According to some embodiments, artifact creator 131 receives selected application data 114 and interaction data 115 from recorder 112, generates corresponding application artifacts and activity artifacts, and generates an automation including the application artifacts and activity artifacts. Storage system 132 of automation system 130 stores automations 133, each including corresponding application artifacts 134 and activity artifacts 135.

Automation system 130 also includes program code executable to provide automation editor 136. A user such as user 120 may operate automation editor 136 to acquire an automation 133 from storage system 132 and to edit the application artifacts 134 and activity artifacts 135 of the automation 133 as is known in the art. The acquired automation 133 may comprise an automation which was automatically-generated using recorder 112 and artifact creator 131 as described herein, or an automation which was manually created by a user as described in the present background.

According to some embodiments, one or more automations 133 may be scheduled for local execution by local computing system 110. Such a scheduled automation is transmitted from system 130 to system 110 and stored, along with its scheduling information, within automations 116. Local computing system 110 also includes program code executable to provide agent 117. As is known in the art, agent 117 executes automations 116 according to their respective schedules. Execution of an automation may include invocation of one or more applications (if not already invoked on system 110) and performance of the activities of the automation on respective user interface elements of the applications in the sequence designated by the automation.

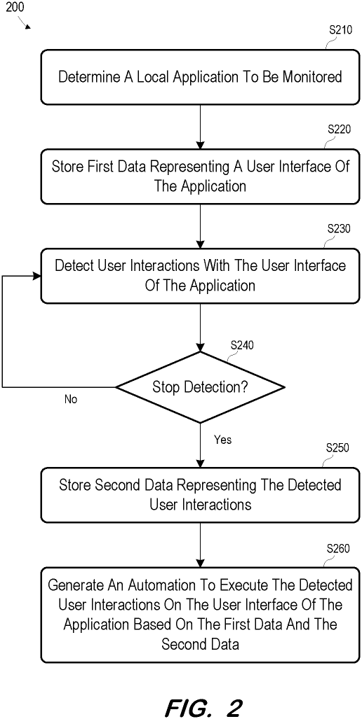

FIG. 2 comprises a flow diagram of process 200 according to some embodiments. Process 200 may be performed by recorder 112 and artifact creator 131 of FIG. 1, but embodiments are not limited thereto. Process 200 and all other processes mentioned herein may be embodied in program code executable by one or more processing units (e.g., processor, processor core, processor thread) and read from one or more of non-transitory computer-readable media, such as a hard disk drive, a volatile or non-volatile random access memory, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Process 200 begins at S210, at which a local application to be monitored is determined. The determination at S210 may be based on a user indication. In some embodiments, a user opens a desired application on a local computing device using any suitable metaphor (e.g., command-line, desktop icon, taskbar icon). Next, the user indicates that interactions with user interfaces of the application should be monitored. The indication may comprise a user interaction with an interface provided by a recorder application such as recorder 112.

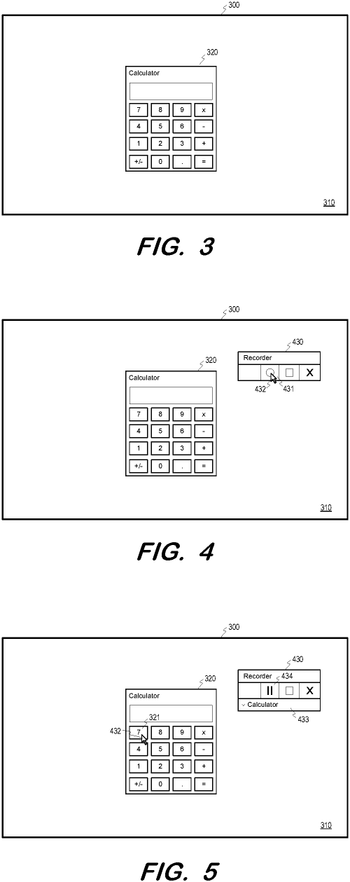

For purposes of example, FIG. 3 illustrates display 300 of a local computing device. Display 300 presents desktop 310 including displayed user interface 320 of a calculator application invoked by user 120 at S210 according to some embodiments. A calculator application is described herein, but embodiments are not limited thereto or to applications including a single static user interface.

User 120 may invoke a recorder application before or after invocation of the calculator application. The recorder application may comprise a functional component of another application, such as a local client application of an automation application. FIG. 4 shows user interface 430 of a recorder application invoked on the local computing device according to some embodiments. User interface 430 includes record button 431 on which user 120 has placed cursor 432. It will be assumed that user 120 selects record button 431 at S210, thereby indicating that the application which has focus at the time of selection is to be monitored. Since the calculator application of user interface 320 currently has focus, it is determined at S210 to monitor the calculator application.

At S220, first data representing the user interface of the determined application is stored. The first data may be stored within application data 114 and may include an image of user interface 320 and data describing the position and type of each user interface control of user interface 320. As shown in FIG. 5, user interface 430 now displays field 433 indicating the application to be monitored. User interface 430 also shows pause button 434 which may be operated as described below. In some embodiments, a user may issue a first instruction (e.g., via the recorder application) to designate an application to be monitored and a second instruction (e.g., selection of a Record button) to begin detecting user interactions with a user interface of the designated application.

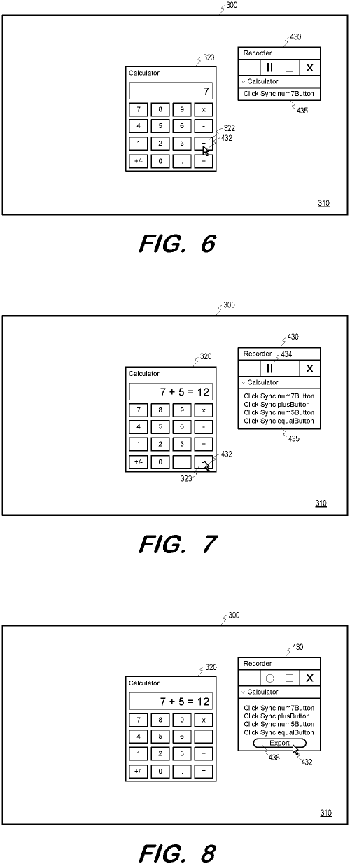

User interactions with the user interface are detected at S230. For example, FIG. 5 also illustrates movement of cursor 432 by user 120 to select button 321 (i.e., “7”) of user interface 320. FIG. 6 shows corresponding indicator 435 of recorder user interface 430 to indicate detection of this user interaction at S230. Embodiments are not limited to indication of detected user interactions in this or any other manner.

Flow cycles between S230 and S240 until it is determined to stop the detection of user interactions. Accordingly, user interactions continue to be detected at S230 until it is determined at S240 to stop the detection of user interactions.

In the present example, FIG. 6 illustrates movement of cursor 432 by user 120 to select button 322 (i.e., “+”) of user interface 320. This selection is detected at S230. It will be assumed that user 120 proceeds to manipulate cursor 432 to select button “5” and button 323 (i.e., “=”) as shown in FIG. 7, both of which are detected at S230, and which result in the sum “12” being displayed by user interface 320. Moreover, indicator 435 indicates detection of each of the above-described user interactions with user interface 320. It should be noted that indicator 435 is associated with the calculator application and that user interface 430 may also present indicators which are associated with other applications if two or more applications are determined at S210 and user interactions with each of the two or more applications are being detected at S230.

It will now be assumed that pause button 434 is selected, causing flow to proceed from S240 to S250. At S250, second data representing the user interactions detected at S230 are stored. The second data may be stored within interaction data 115 of storage 113. In some embodiments, second data representing a user interaction is stored upon detection of the user interaction (i.e., between S230 and S240).

Selection of pause button 434 may result in display of export button 436 as shown in FIG. 8. According to some embodiments, user selection of Export button 436 results in transmission of the first data and the second data to an automation system. For example, in response to selection of Export button 436, recorder 111 may retrieve the stored first data and second data from storage 113 and transmit the first data and second data to artifact creator 131 of automation system 130.

Artifact creator 131 generates an automation at S260 based on the received first data and second data according to some embodiments. The generated automation is to execute the detected user interactions on the user interface of the subject application. Generation of an automation at S260 may comprise generation of an application artifact and activity artifacts based on the first data and second data.

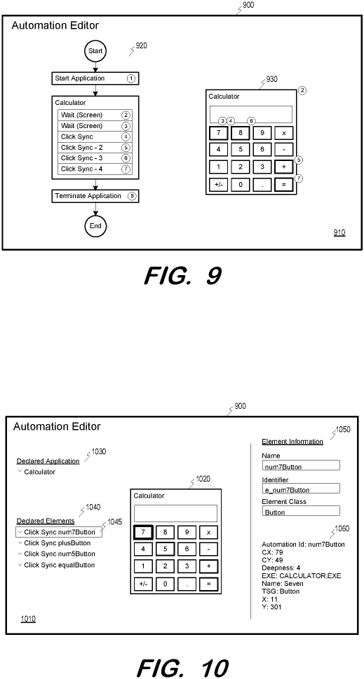

FIG. 9 illustrates display 900 including desktop 910 presenting representation 920 of activity artifacts and representation 930 of an application artifact generated according to the present example. Display 900 may comprise a display of local client system 110 of another system accessing automation system 130.

Representation 920 includes activities 1-8 which are generated based on user interactions with a calculator application user interface which were detected as described above. Representation 930 includes an image of the calculator application user interface and markers 2-7 associating locations of the user interface with respective ones of the activities. Embodiments are not limited to the depiction of activity and application artifacts as shown in FIG. 9.

As described above, a user may edit representation 920 as is known in the art to add, remove, or modify any represented activity. The edited representation may be saved within a new automation associated with current application or may overwrite the originally-generated automation. Either or both automations may be scheduled for execution by a local agent as described above.

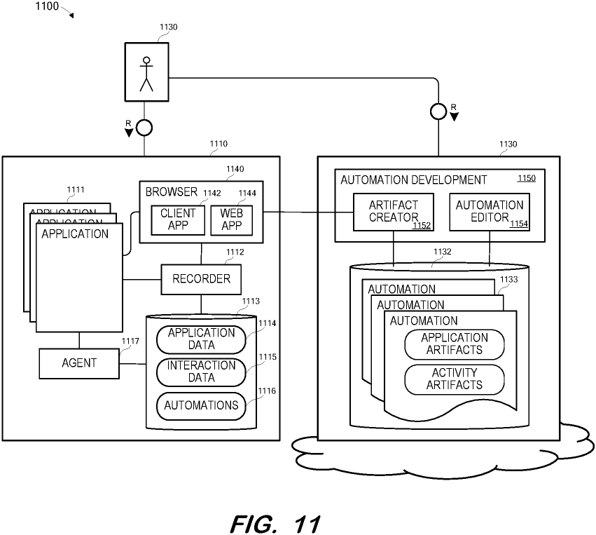

FIG. 10 illustrates a user interface of an automation system presenting an application artifact generated by the automation system according to some embodiments. User interface 1010 shows image 1020 of a user interface of declared application 1030 associated with the application artifact. Delclared elements 1040 of the application artifact include those elements with which a user interaction was detected. All of elements 1040 are highlighted in image 1020 and selected element 1045 is highlighted most prominently. Areas 1050 and 1060 of user interface 1010 provide additional information associated with selected element 1045 by the corresponding application artifact. Embodiments are not limited to the information shown in areas 1050 and 1060.

A user may edit the application artifact using user interface 1010 as is known in the art. The edited application artifact may be saved as a new artifact or may overwrite the original artifact. In some embodiments, either or both of the activity artifacts and the application artifacts of an automation may be edited using functionality provided by the automation system.

FIG. 11 is a block diagram of architecture 1100 according to some embodiments. Architecture 1100 may comprise an implementation of architecture 100 but embodiments are not limited thereto. Elements of architecture 1100 may execute process 200 as described above.

Local computing system 1110 may comprise a computing system operated by local user 1120. Computing system 1110 executes one or more of applications 1111 to provide functionality to user 1120. Computing system 1110 also executes Web browser 1140, which in turn may execute automation client application 1142 and one or more Web applications 1144. Client application 1142 may communicate with a corresponding server application to assist with providing functionality as described herein.

For example, client application 1142 may invoke recorder 1112 in response to commands received from user 1120, and may receive instructions from recorder 1112 to begin or cease detection of user interactions with one or more of applications 1111. Client application 1142 may also detect user interactions with Web application 1144 executing within browser 1140. All detected user interactions may be transmitted to recorder 1112 for storage in storage 1113.

Client application 1142 may export application data 1114 and interaction data 1115 to automation development application 1150, which may comprise a server application associated with client application 1142. Automation development application 1150 includes artifact creator 1152 to generate artifacts from application data and interaction data as described above in or to create an automation 1133. Automation development application 1150 also includes automation editor 1154 to edit artifacts of automations stored in storage system 1132.

Automation development application 1150 may schedule one or more automations 1133 for local execution by local computing system 1110. A thusly-scheduled automation may be transmitted from system 1130 to system 1110 and stored, along with its scheduling information, within automations 1116. Agent 1117 executes automations 1116 within computing system 1110 according to their respective schedules as described above.

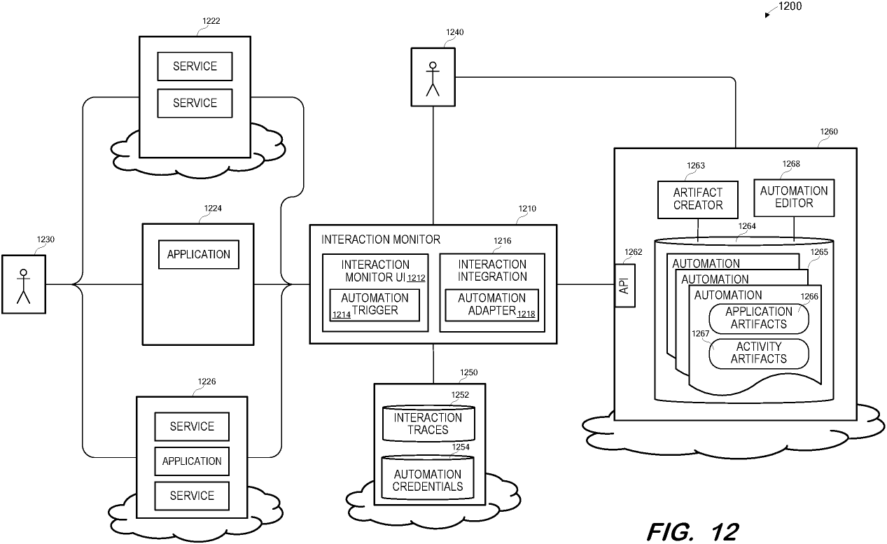

FIG. 12 is a view of architecture 1200 according to some embodiments. Architecture 1200 may operate to automatically generate automations based on monitored user interactions with one or more applications.

Architecture 1200 includes interaction monitor 1210 which may comprise any standalone, distributed, on-premise, and/or cloud-based computing system. Interaction monitor 1210 detects user interactions with applications which may be remote from interaction monitor 1210, in contrast to recorder 112 of FIG. 1 and recorder 1112 of FIG. 11. For example, interaction monitor 1210 may be configured to monitor user interactions with applications executing on one or more remote servers. Interaction monitor 1210 may be deployed within a system landscape to acquire data regarding application usage which may be used to optimize applications and/or the system landscape.

Each of servers 1222, 1224 and 1226 hosts one or more applications and/or services which may be accessed by user 1230. Of course, each of the one or more applications and/or services may be accessed by more than one user, and user 1230 may be authorized to access less than all of the depicted applications and services. According to some embodiments, user 1240 may interact with interaction monitor user interface 1212 to select one or more applications or services whose user interactions will be monitored.

During monitoring of user interactions with an application, interaction monitor 1210 generates interaction traces which represent the user interactions. Interaction traces may identify, among other things, an application, an element of an application user interface, and a user interaction with the element. Interaction monitor 1210 may store the interaction traces within interaction traces 1252 of storage system 1250.

Interaction monitor user interface 1212 includes automation trigger 1214. Automation trigger 1214 may be selected by user 1240 to initiate generation of an automation based on a set of interaction traces stored within interaction traces 1252. According to some embodiments, interaction integration component 1216 of interaction monitor 1210 retrieves the set of interaction traces and, using automation adapter 1218, converts the interaction traces to a format (e.g., JavaScript Object Notation) expected by application programming interface 1262 of automation system 1260. Interaction integration component 1216 uses automation credentials 1254 to authenticate to automation system 1260 and calls application programming interface 1262 to pass the converted interaction traces thereto.

Artifact creator 1263 receives the converted interaction traces, generates corresponding application artifacts and activity artifacts, and generates an automation including the application artifacts and activity artifacts. Unlike the systems described above, the activity artifacts generated by artifact creator 1263 might not include images of application user interfaces, since such images may not be captured along with interaction traces by interaction monitor 1210. Storage system 1264 of automation system 1260 stores automations 1265, each including corresponding application artifacts 1266 and activity artifacts 1267.

A user such as user 1240 may operate automation editor 1268 to acquire an automation 1265 from storage system 1264 and to edit the application artifacts 1266 and activity artifacts 1267 of the automation 1265 as is known in the art. The acquired automation 1265 may comprise an automation which was automatically-generated using artifact creator 1263 as described herein, or an automation which was manually created by a user as described in the present background. Automations 1265 may be scheduled and transmitted to user computing systems for scheduled execution by agents installed thereon.

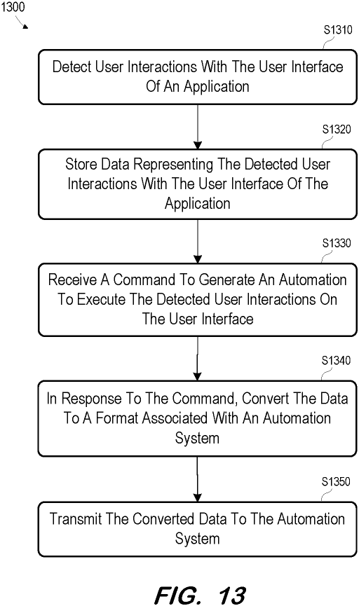

FIG. 13 is a flow diagram of process 1300 to automatically generate automations based on monitored user interactions with one or more applications. According to some embodiments, process 1300 is executed by interaction monitor 1210 of architecture 1200.

Flow begins at S1310, at which user interactions with the user interface of an application are detected. As described above, and in one example, an application is selected using interaction monitor user interface 1212 and subsequent user interactions with a user interface of the application are detected. Data representing the detected user interactions is stored at S1320. The data may comprise interaction traces which include an identifier of the application, identifiers of user interface elements, and user actions taken with respect to the user interface elements.

A command is received at S1330 to generate an automation to execute the detected user interactions on the user interface. The command may be received via selection of automation trigger control 1214 provided by interaction monitor user interface 1212. In response, the stored data is converted to a format associated with an automation system.

According to some embodiments, conversion at S1340 is performed by a script such as but not limited to a python script. The script extracts, from the interaction traces, relevant information associated with the application and the user interface elements, and organizes the information into a simplified structure that may be similar to the format used by the automation system to define application artifacts. The script may also extract from the interaction traces actions performed with respect to the user interface elements, and organize the actions into a simplified structure similar to the format used by the automation system to define automation artifacts.

Next, at S1350, the converted data is transmitted to the automation system. According to some embodiments, the converted data is transmitted via an application programming interface provided by the automation system. Such an application programming interface may facilitate reception of application and user interaction data by the automation system from a variety of sources.

FIG. 14 illustrates display 1400 of an automation system according to process 1300. Display 1400 includes desktop 1410 presenting representation 1420 of activity artifacts generated based on data received from an interaction monitor at S1350. Activity 1422 is associated with application “Easy Access”, for which an application artifact is also generated based on the received data. Configuration area 1430 allows configuration of the selected activity as is known in the art.

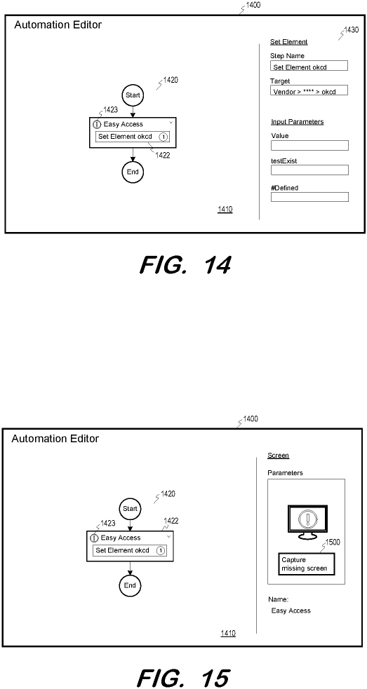

Desktop 1410 does not include an image of a user interface of the associated application, because the stored interaction traces do not include such data. Accordingly, the application is associated with warning icon 1423, which indicates that the corresponding application artifact does not include an image (i.e., a screen capture) of the user interface. According to some embodiments, user selection of icon 1423 results in display of screen capture control 1500 of FIG. 15.

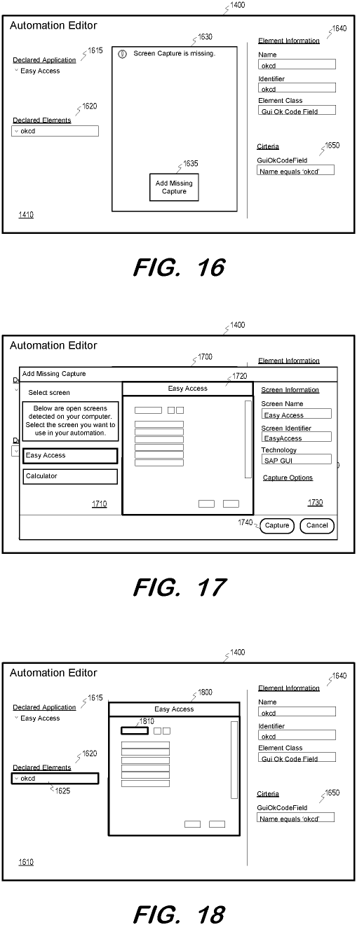

FIG. 16 illustrates desktop 1410 after selection of screen capture control 1500 of FIG. 15 according to some embodiments. Desktop 1410 of FIG. 16 may comprise an application artifact editor. The editor identifies the application 1615 associated with the application artifact, user interface elements 1620 identified in the application artifact, and information 1640 and criteria 1650 for a selected element 1620.

Region 1630 indicates that the screen capture is not available and includes, in the illustrated embodiment, control 1635 which is selectable to add the missing screen capture. FIG. 17 illustrates user interface 1700 which may be displayed upon selection of control 1635. User interface 1700 includes area 1710 which lists currently-open applications and their user interfaces. In the presented example, the application Easy Access is selected in area 1710 and its user interface is therefore presented in area 1720. Area 1730 provides metadata associated with the displayed user interface. Selection of capture button 1740 results in association of the image within area 1720 with the application artifact represented in FIG. 16.

FIG. 18 illustrates the application artifact editor of FIG. 16 with the user interface image 1800 now associated with the presented application artifact. Element 1810 of user interface image 1800 is highlighted to indicate its association with highlighted artifact element 1625. The application artifact, now including image 1800, may be stored in conjunction with one or more automations and used to create additional automations as is known.

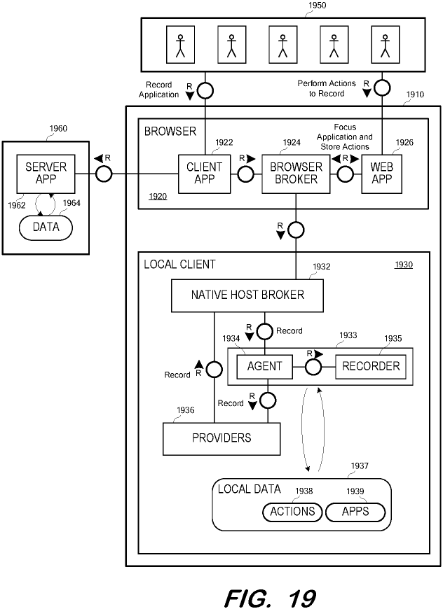

FIG. 19 is a block diagram of an architecture to automatically generate automations based on monitored user interactions with one or more applications according to some embodiments.

Local computing system 1910 executes browser 1920 which in turn executes client application 1922. One of users 1950 may access client application 1922, instruct client application 1922 to open recorder widget 1935 of agent process 1933, and manipulate recorder widget 1935 to issue a command to record interactions with an application. According to the present example, the application is web application 1926 which is also executed by browser 1920.

One of users 1950 may then perform actions upon user interface elements of web application 1926. These actions are passed from browser broker 1924 to native host broker 1932 and then to agent process 1933 for storage as data in local data 1937. Providers 1936 may include drivers for various technologies governing recorded applications.

A user 1950 may further operate recorder widget 1935 to stop recording and to issue a command to export the stored data. In response, browser broker 1924 requests the data from process 1933 which in turn fetches the data from local data 1937. According to some embodiments, process 1933 converts the fetched data to application and activity artifacts as described above and client application 1922 sends the artifacts to server application 1962 of automation system 1960. The artifacts may be user to generate an automation for storage in data 1964 and for possible future execution by agent 1934 of local system 1910.

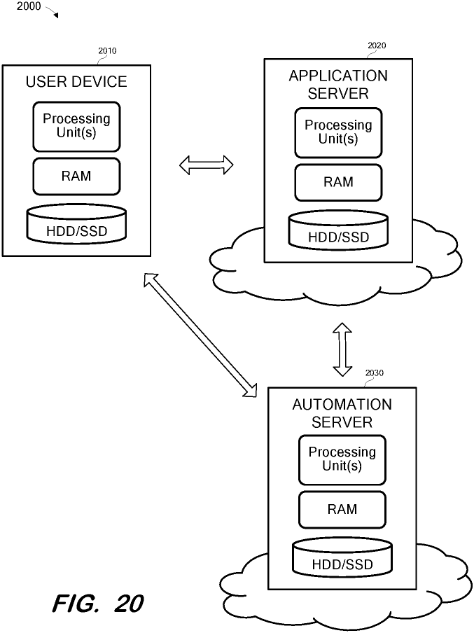

FIG. 20 is a block diagram of cloud-based system 2000 according to some embodiments. In this regard, application server 2020 and automation server 2030 may comprise cloud-based compute resources, such as virtual machines, allocated by a public cloud provider providing self-service and immediate provisioning, autoscaling, security, compliance and identity management features.

User device 2010 may interact with user interfaces of a service or application executing on application server 2020, for example via a Web browser executing on user device 2010. Data representing these interactions may be transmitted from application server 2020 to automation server 2030, directly or via one or more intermediaries. Automation server 2030 may then operate to generate an automation based on this data, where the automation includes an application artifact representing the service or application and activity artifacts representing the detected user interactions. The automation may be transmitted from automation server 2030 to user device 2010 for scheduled automatic execution of the user interactions.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of architectures described herein may include a programmable processor to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

What is claimed is:

1. A method comprising:
determining an executing application;
detecting user interactions with one or more elements of a user interface of the application;
storing data representing the one or more elements of the user interface of the application and the detected user interactions; and
generating, based on the stored data, an automation executable to automatically execute the detected user interactions on the user interface of the application.

2. A method according to claim 1, wherein the stored data representing one or more elements of the user interface of the application and the detected user interactions comprises:
first data representing the one or more elements of the user interface and including an image of the user interface; and
second data representing the detected user interactions.

3. A method according to claim 2, further comprising:
generating an application artifact based on the first data; and
generating activity artifacts based on the second data,
wherein the automation is generated based on the application artifact and the activity artifacts.

4. A method according to claim 3, further comprising:
editing the automation by editing the activity artifacts.

5. A method according to claim 1, further comprising:
generating an application artifact and activity artifacts based on the stored data,
wherein the automation is generated based on the application artifact and the activity artifacts.

6. A method according to claim 5, further comprising:
receiving a user instruction to add an image of the user interface to the application artifact; and
in response to the user instruction, add the image of the user interface to the application artifact.

7. A system comprising:
a memory storing processor-executable program code; and
a processing unit to execute the program code to cause the system to:
detect user interactions with one or more elements of a user interface of an application;
store data representing the one or more elements of the user interface of the application and the detected user interactions;
generate an application artifact and activity artifacts based on the stored data; and
generate an automation executable to automatically execute the detected user interactions on the user interface of the application based on the application artifact and activity artifacts.

8. A system according to claim 7, wherein the stored data representing one or more elements of the user interface of the application and the detected user interactions comprises:
first data representing the one or more elements of the user interface and including an image of the user interface; and
second data representing the detected user interactions.

9. A system according to claim 8, wherein the application artifact is generated based on the first data and the activity artifacts are generated based on the second data.

10. A system according to claim 9, the processing unit to execute the program code to cause the system to:
edit the automation by editing the activity artifacts.

11. A system according to claim 7, the processing unit to execute the program code to cause the system to:
receiving a user instruction to add an image of the user interface to the application artifact; and
in response to the user instruction, add the image of the user interface to the application artifact.

12. A non-transitory computer-readable medium storing program code executable by one or more processing units to cause a computing system to:
detect user interactions with one or more elements of a user interface of an application;
store data representing the one or more elements of the user interface of the application and the detected user interactions; and
generate, based on the stored data, an automation executable to automatically execute the detected user interactions on the user interface of the application.

13. A medium according to claim 12, wherein the stored data representing one or more elements of the user interface of the application and the detected user interactions comprises:
first data representing the one or more elements of the user interface and including an image of the user interface; and
second data representing the detected user interactions.

14. A medium according to claim 13, the program code executable by one or more processing units to cause a computing system to:
generate an application artifact based on the first data; and
generate activity artifacts based on the second data,
wherein the automation is generated based on the application artifact and the activity artifacts.

15. A medium according to claim 14, the program code executable by one or more processing units to cause a computing system to:
edit the automation by editing the activity artifacts.

16. A medium according to claim 12, the program code executable by one or more processing units to cause a computing system to:
generate an application artifact and activity artifacts based on the stored data,
wherein the automation is generated based on the application artifact and the activity artifacts.

17. A medium according to claim 16, the program code executable by one or more processing units to cause a computing system to:
receive a user instruction to add an image of the user interface to the application artifact; and
in response to the user instruction, add the image of the user interface to the application artifact.
